(19) United States
(12) Patent Application Publication
(10) Pub. No.: US 2009/0119620 A1
(43) Pub. Date: May 7, 2009

(54) Method and Apparatus for Hardware Controlled Intelligent Web Content Navigation System

(76) Inventors: Ashish Jain, Raleigh, NC (US); Payal Chakravarty, Raleigh, NC (US)

Correspondence Address: DUKE W. YEE, YEE & ASSOCIATES, P.C., P.O. BOX 802333, DALLAS, TX, 75380, US

(21) Appl. No.: 11/935,937

(22) Filed: Nov. 6, 2007

(51) Int. Cl. G06F 3/048

(52) U.S. Cl. 715/854

(57) ABSTRACT

A navigational plug-in (NP) for the web browser identifies a web page by uniform resource locator address and parses the web page for a navigational control. The NP then maps a new and additional controller to the navigational control so that the user has the option of a single operation to activate the navigational control. Examples of a single operation are an exclusive key on the mouse or a specific key combination on the keyboard.

### FIELD OF THE INVENTION

The present invention relates generally to data processing and specifically to improved navigation of web pages by navigational controls.

### BACKGROUND OF THE INVENTION

Web users frequently encounter data which spans multiple web pages. Web users typically navigate through multiple web pages using navigational controls provided on the web page in the form of “next” and “previous” buttons. For example, “next” and “previous” buttons are used when browsing search results returned by a search engine, when reading a tutorial, and when reading a web based book. Currently, the only way to effect navigation using “next” or “previous” buttons is to explicitly click the “next” or “previous” button using either the mouse or the keyboard. When the user interacts with a screen, the user must move the cursor around the screen by moving the mouse until the cursor is positioned over the “next” or “previous” button control. Then the user must activate the control by clicking the mouse. The operation of moving the cursor to the “next” or “previous” button and then clicking the control to activate it takes time and effort that adds up on repeated operations.

A need exists for a way to improve navigation of web pages by reducing steps and time in navigating web pages.

### SUMMARY OF THE INVENTION

A navigational plug-in (NP) for the web browser identifies a web page by uniform resource locator address and parses the web page for a navigational control. The NP then maps a new and additional controller to the navigational control so that the user has the option of a single operation to activate the navigational control. Examples of a single operation are an exclusive key on the mouse or a specific key combination on the keyboard.

### BRIEF DESCRIPTION OF DRAWINGS

The novel features believed characteristic of the invention are set forth in the appended claims. The invention itself, however, as well as a preferred mode of use, further objectives and advantages thereof, will be understood best by reference to the following detailed description of an illustrative embodiment when read in conjunction with the accompanying drawings, wherein:

FIG. 1 is an exemplary computer network;

FIG. 2 describes programs and files in a memory on a computer;

FIG. 3 depicts an exemplary address menu;

FIG. 4 depicts control and controller menu;

FIG. 5 is a flowchart of a configuration component;

FIG. 6 is a flowchart of an detection component; and

FIG. 7 is a flowchart of a mapping component.

### DETAILED DESCRIPTION OF THE PREFERRED EMBODIMENT

The principles of the present invention are applicable to a variety of computer hardware and software configurations. The term “computer hardware” or “hardware,” as used herein, refers to any machine or apparatus that is capable of accepting, performing logic operations on, storing, or displaying data, and includes without limitation processors and memory. The term “computer software” or “software,” refers to any set of instructions operable to cause computer hardware to perform an operation. A “computer,” as that term is used herein, includes without limitation any useful combination of hardware and software, and a “computer program” or “program” includes without limitation any software operable to cause computer hardware to accept, perform logic operations on, store, or display data. A computer program may, and often is, comprised of a plurality of smaller programming units, including without limitation subroutines, modules, functions, methods, and procedures. Thus, the functions of the present invention may be distributed among a plurality of computers and computer programs. The invention is described best, though, as a single computer program that configures and enables one or more general-purpose computers to implement the novel aspects of the invention. For illustrative purposes, the inventive computer program will be referred to as the “Navigational Plug-in” or “NP.”

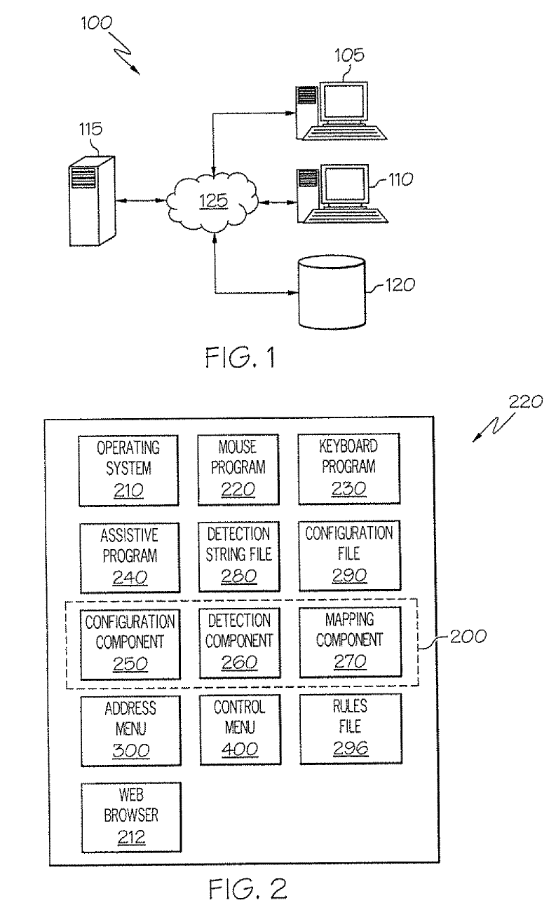

Additionally, the NP is described below with reference to an exemplary network of hardware devices, as depicted in FIG. 1. A “network” comprises any number of hardware devices coupled to and in communication with each other through a communications medium, such as the Internet. A “communications medium” includes without limitation any physical, optical, electromagnetic, or other medium through which hardware or software can transmit data. For descriptive purposes, exemplary network 100 has only a limited number of nodes, including workstation computer 105, workstation computer 110, server computer 115, and persistent storage 120. Network connection 125 comprises all hardware, software, and communications media necessary to enable communication between network nodes 105-120. Unless otherwise indicated in context below, all network nodes use publicly available protocols or messaging services to communicate with each other through network connection 125.

NP 200 typically is stored in a memory, represented schematically as memory 220 in FIG. 2. The term “memory,” as used herein, includes without limitation any volatile or persistent medium, such as an electrical circuit, magnetic disk, or optical disk, in which a computer can store data or software for any duration. A single memory may encompass and be distributed across a plurality of media. Further NP 200 may reside in more than one memory distributed across different computers, servers, logical partitions, or other hardware devices. The elements depicted in memory 220 may be located in or distributed across separate memories in any combination, and NP 200 may be adapted to identify, locate and access ally of the elements and coordinate actions, if any, by the distributed elements. Thus, FIG. 2 is included merely as a descriptive expedient and does not necessarily reflect any particular physical embodiment of memory 220. NP 200 has configuration component 500, detection component 600, and modification component 700. As depicted in FIG. 2, though, memory 220 may include additional data and programs. Of particular import to NP 200, memory 220 includes operating system 210, mouse program 220 keyboard program 230, web browser 212, assistive program 240, detection string file 280, configuration file 290, rules file 296, address menu 300, and control and controller menu 400.

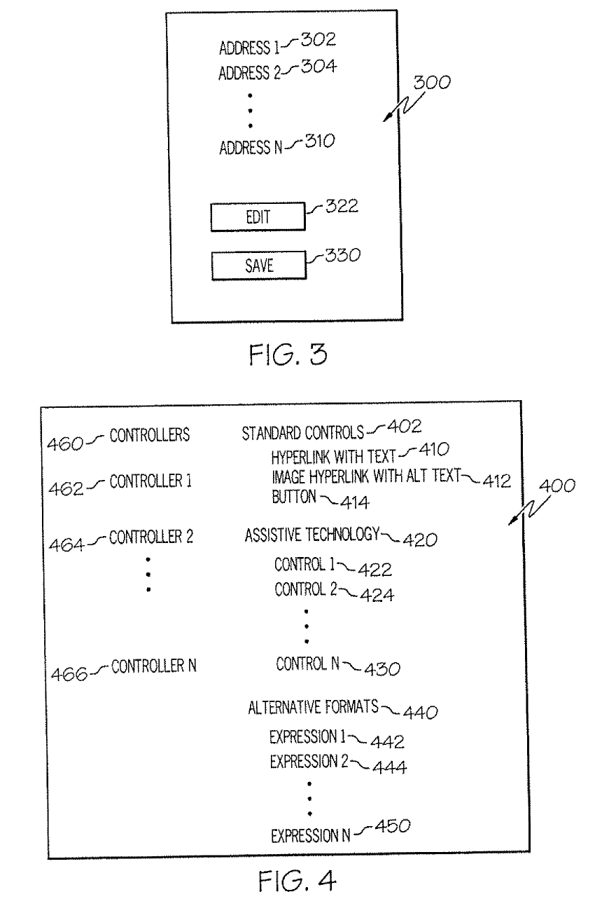

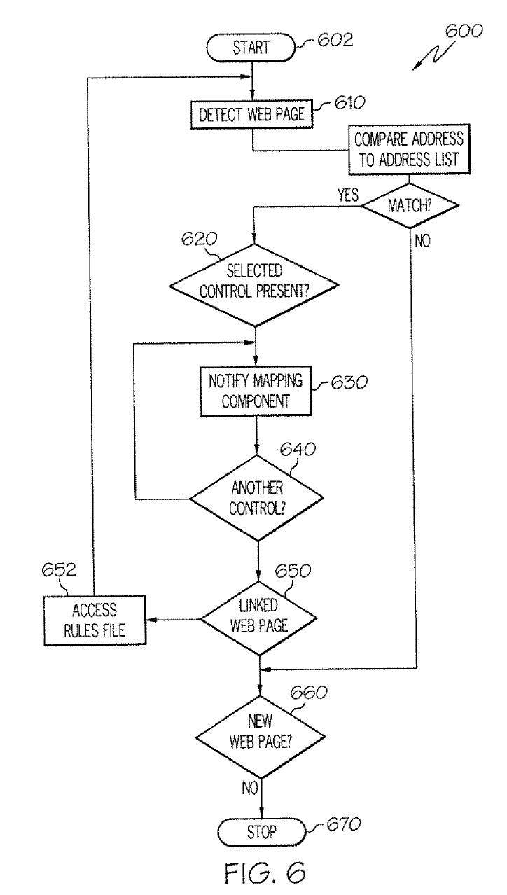

FIG. 3 depicts an exemplary address menu 300. Address menu 300 includes a list of uniform resource locator addresses represented in FIG. 3 by address 1 302, address 2 304 through address N 310. Edit control 322 allows the user to make additions, deletions, or corrections to the addresses in the list. Persons skilled in the art will be aware that addresses can be designated using wild card terms in order to expand the range of addresses NP 200 will seek to match. For example, a term such as *.cnn.com can represent all cnn.com addresses, and any address containing “ccn.com” would match the wild card term *.ccn.com. Additionally, the user will arrange the list of addresses in the priority in which NP 200 will seek to match web page addresses to the addresses in the list (See FIG. 6) After the user has placed the address list in the priority desired, the selections are saved to configuration file 290 by activating save control 330.

FIG. 4 depicts an exemplary control and controller menu 400. Control and controller menu 400 displays three control lists: standard controls 402, assistive technology controls 420, and alternate format controls 440. Control and controller menu 400 also displays controllers list 460 with specific controllers in the list represented by controller 1 462, controller 2 464 through controller N 466. Referring to the control lists, standard controls 402 lists “hyperlink with text” 410, “image hyperlink with alt text” 412, and “button” 414 (the button having a value of “next” or “next page”). Assistive technology controls 420 lists controls associated with assistive program 240 depicted as “control 1” 422 and “control 2” 424 through “control n” 430. Alternate format controls 440 lists alternate expressions for “next” or “next page” shown in FIG. 4 as “expression 1” 442, “expression 2” 444 through “expression n” 450. For example, when a control is not identified by “next” or “next page” as listed in standard controls 402, then the control is in an alternate format. Using alternate formats 440, the user can specify website specific detection strings from detection string file 280 using expressions which enable the system to detect the controls on that website that are in alternate formats.

Referring to controller list 460, controller 1 464 through controller N 466 may be a key on the keyboard, a specific key-combination on the keyboard, an exclusive key on the mouse, a voice command (when assistive technology is available), or some other single operation that may be suitable for activating a control. In operation, a user accesses control and controller menu 400, selects a control from one of the control lists by highlighting the control, and then selects a controller from controller list 460 by clicking on the control. By way of example, if a user highlighted button 414 and then clicked on controller 1 462, then controller 1 462 would be associated with control button 414 and the association would be saved to configuration file 290. After the user makes all selections and associations from control and controller menu 400, the selections and associations are saved to configuration file 290. Persons skilled in the art will be aware of many additional ways in which to identify controls and to associate controllers.

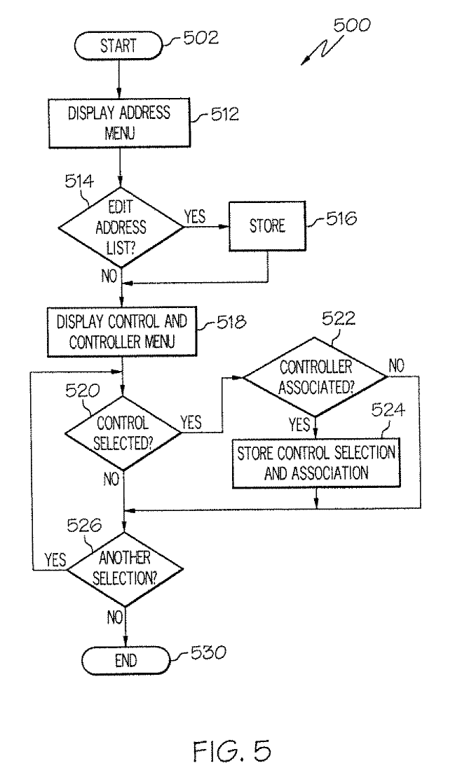

Referring to FIG. 5, configuration component 500 starts (502) and displays address menu 300 (512). CC 300 determines whether the user has edited the address list (514). If the user edited the address list, CC 500 stores the new address list in configuration file 290 (516). After storing the new address list in configuration file 290, or if the user did not edit the address list at step 514, CC 300 displays control menu (518). CC 300 determines whether the user selected a control from control menu (520). If the user selected a control, CC 500 determines whether the user has associated a controller with the selected control (522). If the user has associated a controller with the selected control, CC 500 stores the control selection in configuration file 290 (524). CC 500 determines whether there is another selection to be made (526). If so, CC 500 goes to step 520, and if not, CC 500 stops (530).

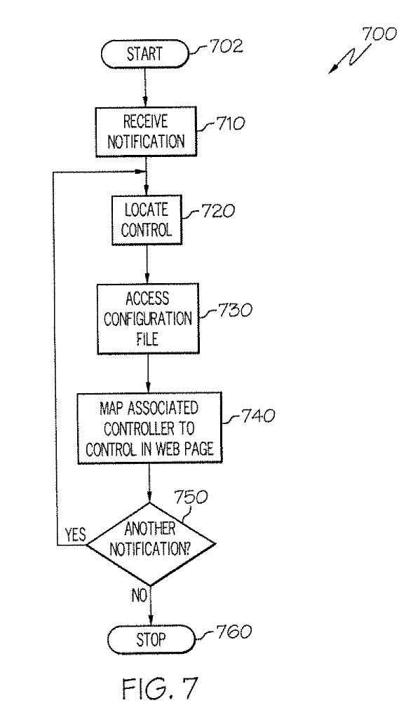

Referring to FIG. 6, Detection Component (DC) 600 starts (602) when a web page is detected (610). DC 600 compares the uniform resource locator address for the web page to the address list in configuration file 290 (612) and determines whether the uniform resource locator address matches an address in the list. DC 600 will make the comparison in the priority order of the list. When a match is made DC, 600 goes to step 620. If no match is made, DC 600 goes to step 660. At step 620, DC 600 determines whether a control selected by the user and stored in configuration file 290 is present. If a control selected by the user and stored in configuration file 290 is present, DC 600 notifies mapping component 270, and determines whether another control selected by the user and saved to configuration file 290 is included in the web page (620). For example, the control options provided by CC 300 in control menu 400 are a text hyperlink 410, image hyperlink 412, or control button 414. If the user selected image hyperlink 412 then image hyperlink 412 was saved to configuration file 290. When DC 600 detects an image hyperlink in the web page, DC 600 notifies MC 700 (see FIG. 7) of the control (630). If DC 600 determines there is another selected control in the web page (640), DC 600 returns to step 630. When another selected control is not detected, DC 600 determines whether there are other web pages linked to the displayed web page (650). For example, the web page may have a next page, a previous page, or both. If there is another web page linked to the displayed web page, DC 600 accesses rules file 296 (652) to determine the order in which to access the additional web pages. A web page will be selected either according to a default rule or according to a rule configured by the user, and DC 600 goes to step 610. When there are no other linked web pages (650), DC 600 determines whether there is a new web page (660). If so, DC 600 goes to step 610, and if not, DC 600 stops (670).

DC 600 detects navigation controls through standardized specification of the selected controls. In one embodiment, standardized HTML markup specifies the navigation controls so that the navigation controls can be parsed via any HTML parsing user agent. The standardized HTML markup is included as a part of the HTML specification. An example of such a HTML markup would be:

<html>
<head><next>
<body nextPage=“nextPageLinkURL”
previousPage=“previousPageLinkUrl”>
BodyContent goes here
</body>
</html>

The above example avoids ambiguity of the next and previous page controls since there can be only one body tag. But visual navigational controls may still need to be displayed on the page. In another embodiment, page navigation is included in HTML markup as follows.

<a nextpagelink=“true”href=“nextPageLinkUrl”>Next Page </a>
<a nextpagelink=“true”href=“nextPageLinkUrl”> <img src=“nextPageNavigationalArrow.jpg”/> <a>

Referring to FIG. 7, MC 700 starts when a notification is received from DC 600 (702). MC 700 receives notification of a selected control (710), locates the control (720), and accesses configuration file 290 (730). MC 700 maps the controller associated with the control specified in configuration file 290 (740). MC 700 determines whether there is another notification of a control (750). If there is another notification, MC 700 goes to step 720. If not, MC 700 stops (760).

In operation, NP 200 can enable a controller such as an extra key on the mouse or a key combination on the keyboard that has been associated with a particular type of control to activate the control to navigate a web page. NP 200 allows a user to add an additional controller to the user's options for activating a navigational control in a single operation. The user can still activate the control by moving a mouse and cursor until the cursor is on the control and then clicking the mouse. But the user now has an alternate way to navigate the page such as striking a pre-selected key or key-combination on the keyboard, thus saving the time taken to move the cursor into position. The new control is mapped to the control on the web page, and the process is transparent to the user. When a web page with a uniform resource locator matching an address in the priority list is found, and the web page contains a control selected by the user, then the controller selected by the user is mapped to the control, and the user may activate the control by either the existing method or by the newly mapped controller such as an exclusive key on the mouse or a specific key combination on the keyboard. NP 200 does not change the rendering of a web page and is completely non-intrusive to users who have not elected to use NP 200.

A preferred form of the invention has been shown in the drawings and described above, but variations in the preferred form will be apparent to those skilled in the art. The preceding description is for illustration purposes only, and the invention should not be construed as limited to the specific form shown and described. The scope of the invention should be limited only by the language of the following claims.

What is claimed is:

1. A computer implemented process for modifying a control device, the computer implemented process comprising:
loading a navigational program into a memory connected to a computer, the navigational program containing instructions encoded thereon, to cause the computer to perform the following steps:
responsive to display of a web page on a display connected to the computer, detecting a navigational control on the web page;
responsive to detecting the navigational control, mapping a user configured controller to the navigational control so that the navigational control can be activated by a single operation.

2. The computer implemented process of claim 1 wherein the control device is a mouse and the single operation is an activation of an exclusive key on the mouse.

3. The computer implemented process of claim 1 wherein the control device is a keyboard and the single operation is an activation of a specific key combination on the keyboard.

4. The computer implemented process of claim 1 further comprising specifying website specific detection strings from a detection string file so that controls on the web page in an alternate format will be detected.

5. The computer implemented process of claim 1 wherein the step of detecting the navigational control on the web page further comprises using a standardized specification of a selected control so that the navigational control can be parsed by any hypertext markup language parsing user agent.

6. The computer implemented process of claim 1 further comprising: identifying a web page by comparing the web page uniform resource locator address to an address list in a configuration file, and only mapping a controller to a control if the web page uniform resource locator address matches one of the addresses in the address list.

7. An apparatus comprising:
A computer connected to a memory;
a navigational program encoded in the memory, the navigational program containing instructions encoded thereon, to cause the computer to display a web page on a display connected to the computer, detect a navigational control on the web page, and responsive to detecting the navigational control, mapping a user-configured controller to the navigational control so that the navigational control can be activated by a single operation.

8. The apparatus of claim 7 wherein the control device is a mouse and the single operation is an activation of an exclusive key on the mouse.

9. The apparatus of claim 7 wherein the control device is a keyboard and the single operation is an activation of a specific key combination on the keyboard.

10. The apparatus of claim 7 further comprising specifying website specific detection strings from a detection string file so that controls on the web page in an alternate format will be detected.

11. The apparatus claim 7 further comprising a standardized specification of a selected control so that the navigational control can be parsed by any hypertext markup language parsing user agent.

12. The apparatus of claim 7 wherein the computer is further caused to compare the web page uniform resource locator address to an address list in a configuration file, and only map a controller to a control if the web page uniform resource locator address matches one of the addresses in the address list.

13. A computer readable memory for causing a computer to modify activation of web page navigational controls, comprising:
a computer readable storage medium;
a computer program stored in the computer readable storage medium;
the computer readable storage medium, so configured by the computer program, causes the computer to perform the following steps:
responsive to display of a web page on a display connected to the computer, detecting a navigational control on the web page;
responsive to detecting the navigational control, mapping a user configured controller to the navigational control so that the navigational control can be activated by a single operation.

14. The computer readable memory of claim 13 wherein the control device is a mouse and the single operation is an activation of an exclusive key on the mouse.

15. The computer readable memory of claim 13 wherein the control device is a keyboard and the single operation is an activation of a specific key combination on the keyboard.

16. The computer readable memory of claim 13 further comprising: website specific detection strings from a detection string file so that controls on the web page in an alternate format will be detected.

17. The computer readable memory of claim 13 wherein the step of detecting the navigational control on the web page further comprises using a standardized specification of a selected control so that the navigational control can be parsed by any hypertext markup language parsing user agent.

18. The computer readable memory of claim 13 further comprising: identifying a web page by comparing the web page uniform resource locator address to an address list in a configuration file, and only mapping a controller to a control if the web page uniform resource locator address matches one of the addresses in the address list.
